(19) United States
(12) Patent Application Publication
(10) Pub. No.: US 2025/0125630 A1
(43) Pub. Date: Apr. 17, 2025

(54) SYSTEMS AND METHODS FOR MICROGRID ASSET DISPATCH

(71) Applicant: Caterpillar Inc.

(72) Inventors: Suresh Baddam REDDY, Peoria, IL (US); Srideep CHATTERJEE, Madhya Pradesh (IN); Ranjay Singh, Uttar Pradesh (IN); Sowmya NAGESH, Peoria, IL (US); Leo Roger Edward Shead, Peterborough (GB)

(73) Assignee: Caterpillar Inc., Peoria, IL (US)

(21) Appl. No.: 18/488,587

(22) Filed: Oct. 17, 2023

(51) Int. Cl. H02J 3/46; H02J 3/32; H02J 3/38

(52) U.S. Cl. CPC H02J 3/466; H02J 3/32; H02J 3/381; H02J 2300/22

(57) ABSTRACT

A method of operating a microgrid system includes: obtaining a microgrid dispatch schedule input that includes a schedule of required electrical energy generation for the microgrid system for a given time period; filtering the scheduled dispatch input and converting the scheduled dispatch input into power levels to meet power demands for required electrical energy generation of the dispatch schedule input for the microgrid system; receiving a current load level for the microgrid system based on one or more electrical loads electrically coupled to the microgrid system; comparing the schedule of required electrical energy generation to an actual required electrical energy generation for the microgrid system; and dispatching one or more electrical assets in real time to meet a difference between the scheduled required electrical energy generation and the actual required electrical energy generation.

### TECHNICAL FIELD

The present disclosure relates generally to systems and methods for dispatching electrical assets on a microgrid, and more particularly, to systems and methods for flexibly dispatching electrical assets in real time.

### BACKGROUND

Managing hybrid power systems on microgrids can be a complex task, but it can be beneficial to optimize microgrid performance and can result in realized benefits, such as cost reduction, emissions reduction, and improved reliability. Hybrid power systems combine multiple modes of electricity generation and storage, which can include solar panels, wind turbines, batteries, and traditional grid connections. Coordinating these various assets to operate efficiently can be challenging due to the diversity of technologies and their interactions. Rule-based algorithms can be simple to implement but may fail to account for all possible scenarios, especially in hybrid systems with high levels of complexity. These approaches can require predefined rules and can miss edge cases, leading to suboptimal performance. Meanwhile, optimization techniques, (e.g., linear programming, mixed-integer programming, etc.) can find optimal solutions to complex problems. However, as the complexity of hybrid power systems increases, computational demands may become prohibitively high. Moreover, conventional optimization may not consider type-specific aspects of power assets, such as maintenance, degradation, or replacement.

U.S. Pat. No. 10,734,811, (“the '811 patent”), describes methods and systems for optimizing control of one or more energy storage systems (“ESS”). According to the '811 patent, a system can includes data sources, a forecast engine, a scheduling and dispatch engine, an ESS control system, and an optimization block. The scheduling and dispatch engine determines a dispatch schedule for the ESS based on optimization methods. The ESS control system can determine a real and reactive power input or extract from a grid or microgrid based on the dispatch schedule received from the scheduling and dispatch engine. The system may use various algorithms such as a rule scheduler. However, the '811 patent does not account for various aspects of power assets that are type-specific, and moreover does not address the issue of computational complexity as the number of power assets increases.

The systems and methods for flexibly dispatching electrical assets in real time of the present disclosure may address one or more problems in the art, for example, problems not addressed by the '811 patent. The scope of the current disclosure, however, is defined by the attached claims, and not by the ability to solve any specific problem.

### SUMMARY

In one aspect, a method of operating a microgrid system includes: obtaining a microgrid dispatch schedule input that includes a schedule of required electrical energy generation for the microgrid system for a given time period and a schedule of electrical assets capable of meeting the schedule of required electrical energy generation; filtering the scheduled dispatch input and converting the scheduled dispatch input into power levels to meet power demands for required electrical energy generation of the dispatch schedule input for the microgrid system; receiving a current load level for the microgrid system based on one or more electrical loads electrically coupled to the microgrid system; comparing the schedule of required electrical energy generation to an actual required electrical energy generation for the microgrid system to determine a difference between scheduled required electrical energy generation and the actual required electrical energy generation; and dispatching one or more electrical assets in real time to meet a difference between the scheduled required electrical energy generation and the actual required electrical energy generation.

In another aspect, a method of operating a microgrid system includes receiving a scheduled load signal based on a schedule of electrical load requirements for the microgrid system for a given period of time; receiving an expected power generation signal based on an expected power generation of one or more electrical assets electrically coupled to the microgrid system; measuring an actual load at a measuring time that is within the given period of time and receiving an actual load signal to determine an actual load on the microgrid system; comparing the actual load signal with the scheduled load signal and the expected power generation signal; developing a differential load signal based on a difference between the scheduled load signal, the expected power generation signal, and the actual load signal; dispatching one or more electrical assets to meet the differential load based on the differential load signal.

In yet another aspect, a controller for a microgrid system includes at least one memory storing instructions; at least one processor, operatively connected to the memory and configured to execute the instructions to: receive a scheduled load signal based on a schedule of electrical load requirements for the microgrid system for a given period of time; receive an expected power generation signal based on an expected power generation of one or more electrical assets electrically coupled to the microgrid system; measure an actual load at a measuring time that is within the given period of time and receiving an actual load signal to determine an actual load on the microgrid system; compare the actual load signal with the scheduled load signal and the expected power generation signal; develop a differential load signal based on a difference between the scheduled load signal, the expected power generation signal, and the actual load signal; dispatch one or more electrical assets to meet the differential load based on the differential load signal.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic system diagram showing a microgrid system, according to aspects of the disclosure.

FIG. 2A is an exemplary system controller for controlling the microgrid system of FIG. 1.

FIG. 2B is another embodiment of an exemplary system controller for controlling the microgrid system of FIG. 1.

FIG. 3A shows an exemplary method of dispatching loads in real time to meet load requirements including any charging requirements using, for example, the system controller of FIG. 2A.

FIG. 3B shows another exemplary method of dispatching loads in real time to meet load requirements including any charging requirements using, for example, the system controller of FIG. 2B

FIG. 4 shows an exemplary method of operating a microgrid system, such as the microgrid system of FIG. 1.

FIG. 5 shows another exemplary method of operating a microgrid system, such as the microgrid system of FIG. 1.

FIGS. 6A-6B are charts showing a scheduler profile filtering function of one or more of the exemplary scheduling modules shown and described herein, for example, the scheduling modules in the system controllers of FIGS. 2A and 2B.

FIG. 7 shows a scheduled charge request versus time for a microgrid system such as the microgrid of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

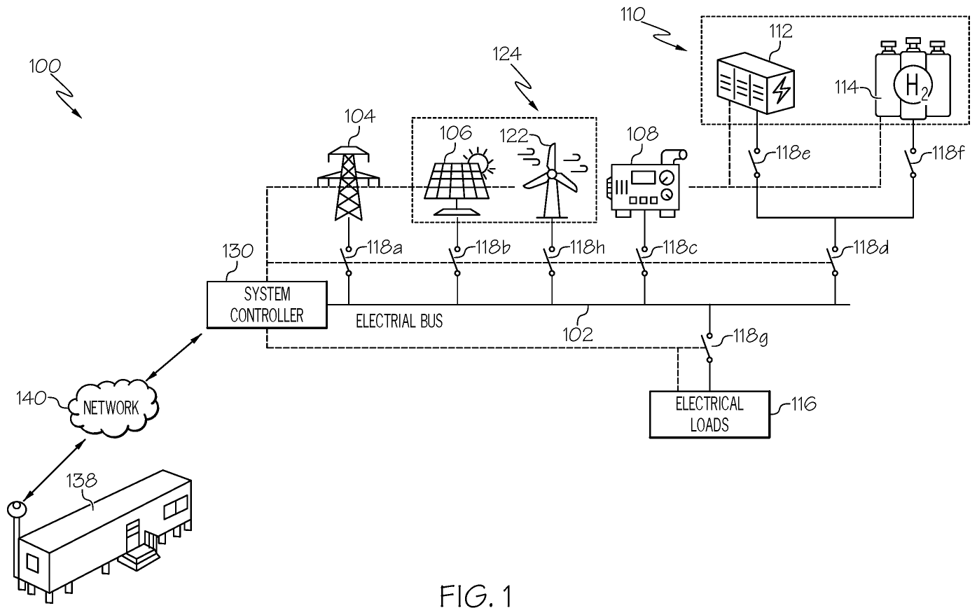

FIG. 1 shows an exemplary microgrid 100. The microgrid 100 includes an electrical bus 102 with multiple assets (which can be arranged into asset groups in any arrangement) and loads attached to the electrical bus 102. Non-limiting examples of assets that can be attached to the electrical bus include a utility grid 104, one or more renewable asset groups 124, including, for example, a photovoltaic asset 106 and a wind turbine asset 122, one or more gensets 108, and one or more energy storage systems (ESS) groups 110. While FIG. 1 shows only one icon of select asset types, it is understood that the microgrid can embody any set of diverse renewable and non-renewable assets in any combination. For example, the photovoltaic asset 106 can be replaced by any combination of assets that rely on photovoltaics, wind turbines, geothermal, hydroelectric, biomass, tidal, biofuel, and the like. Similarly, the gensets 108 can embody any combination of rotor-stator combinations driven by a prime mover such as gas, diesel, dynamic gas blending (DGB) combustion engine that can operate at a constant speed or variable speeds and can include any type of electrical generator, for example, without limitation, a diesel generator, a gas reciprocating generator, a gas turbine generator, a hydrogen reciprocating generator, generators with any blends of fuels, etc. ESS assets can include, without limitation, a battery type ESS 112 (lead-acid, Li-ion, etc.), a hydrogen storage ESS 114, and other types of ESS. For example, ESS assets on the microgrid 100 can include electrochemical units with various rechargeable battery chemistries, lithium-ion, high-power lead acid, fuel cells, ultra-capacitors, flow batteries, etc. or mechanical storage including flywheels, pumped hydro, compressed air storage, gravitational potential energy, etc. or thermal storage, and the like. The microgrid 100 can further include various loads 116. In some embodiments, these loads 116 may be uncontrollable, but some of them may be smart loads that can be commanded by the system controller 130. Each of the various assets and loads can be separable from the electrical bus 102 by a breaker 118 (118a-118h) for isolating the various assets and loads from the electrical bus 102.

The assets and/or asset groups, loads, and breakers can be controllable, at least in part, by one or more controllers. For example, the microgrid 100 may have a system controller 130 that may be capable of controlling one or more of the asset groups, loads, or other components of the microgrid 100. For example, in some embodiments, the system controller 130 may control the breakers 118 to open or close the breakers, placing energy resource groups and/or loads on the microgrid 100. Additionally, the system controller 130 may control the opening or the closing of one or more tie breakers (not shown) between different electrical buses to open or close tie breakers between the individual buses to electrically connect different buses (in embodiments of the microgrid having multiple buses). In embodiments having multiple buses, each of the buses may form its own electrical grid when isolated from the others. Further, two of the buses may form an electrical grid separate from the other bus. The system controller 130 may be connected to a back office 138 via a network 140 (e.g., a cloud network) or other connection. The system controller 130 may be configured to compare an actual output of the plurality of power sources on the microgrid 100 to a desired output and selectively control and adjust the power output of each power source to meet the power demand of the loads 116 as explained in greater detail herein.

The multiple breakers 118 selectively connect buses, electrical assets, and electrical loads. The breakers may be circuit breakers that connect two buses or sections of an electrical bus serving different power sources or different electrical buses. When closed, current can pass in either direction between them, flowing from source(s) to sink(s). Each breaker is associated with the two electrical buses or portions of a bus it connects. Different portions of a bus or different buses could also be controlled by other controllers connected to the bus, for example, other controllers similar to the system controller 130.

The system controller 130 may communicate at the energy resource group controller level or may communicate with individual asset controllers. The system controller 130 can be located anywhere. For example, the system controller 130 can be located on site (e.g., in the back office 138) or remotely. The back office 138 can include one or more interfaces for an operator to input configuration inputs to configure the microgrid. In some embodiments, the back office 138 may also receive operational inputs and provide interfaces to view one or more configuration or operational outputs (e.g., on a display configured to display monitor microgrid operation).

The system controller 130 may manage the electrical grid using one or more commands. For example, the system controller 130 may generate one or more individual asset on/off commands for placing gensets, fuel cells, and other controllable assets on the grid. Renewable assets, such as photovoltaic assets can be placed on the grid, but in some instances, due to their nature, these assets may be taken off of the grid due to reduced capacity (e.g., failures, environmental conditions (e.g., lack of sunlight, lack of wind, etc.), etc.)

The system controller 130 can monitor the maximum available power supplied by the non-ESS assets available to the microgrid 100 (e.g., the utility grid 104, the photovoltaic assets 106, and the gensets 108). If the non-ESS assets alone cannot manage the loads 116, the system controller 130 can enable the ESS group 110 to supplement load sharing. If the load is less than what the non-ESS assets need to supply at a minimum, the system controller 130 can redirect excess power from the electrical bus 102 to the ESS group 110 to store the excess power as reserve power in one or more assets of the ESS group 110. Additionally, the energy storage is used as a buffer for economic operation of non-energy storage assets, i.e. charging/discharging to bring the non-energy storage assets operation to an economic operation range. Charging/discharging may be enabled to keep energy storage within limits of State of Charge (SOC) or State of Energy (SOE), i.e. enable charging when SOC/SOE is below a minimum, or enable discharging when SOC/SOE is above a maximum. In some embodiments, the system controller 130 may not use available electrical capacity to charge the ESS group 110 if, for example, energy costs are currently high (e.g., high cost of electricity from the utility grid 104) or there is insufficient power from one or more renewable sources of energy. In embodiments, the system controller 130 can evaluate one or more of a volatility factor for intermittent sources, a kW/kVA threshold, an available power source(s), and one or more other factors to determine a cost function associated with using electrical energy from each asset and/or the microgrid as a whole.

The network 140 can be, for example, a wired or wireless network, Wi-Fi, or a cellular network that includes a plurality intercommunication devices (e.g., modems, Wi-Fi, cellular devices, etc.) The network 140 can include one or more satellites and one or more ground stations (e.g., the back office 138), wherein the ground stations may be configured to wirelessly communicate to transmit and receive data from the satellites.

Each of the multiple ESS groups 110 can be of varying type with varying characteristics. The ESS systems deployable on the microgrid 100 can include batteries of different capacities, chemistries, and with other different characteristics. One or more of the multiple ESS groups 110 can also include hydrogen storage systems with one or more electrolysers and/or one or more pumped hydro systems.

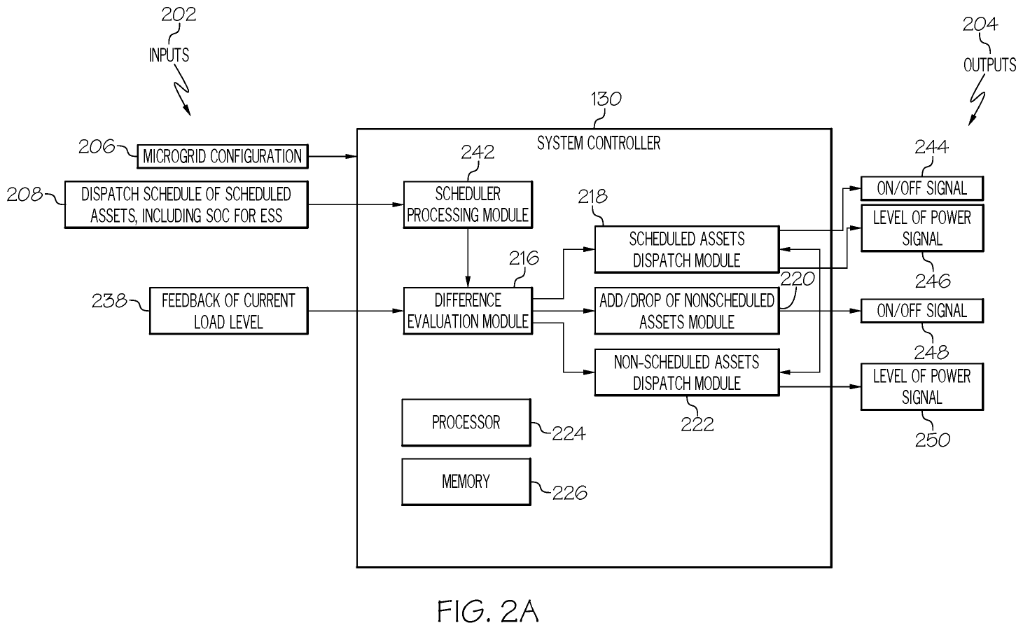

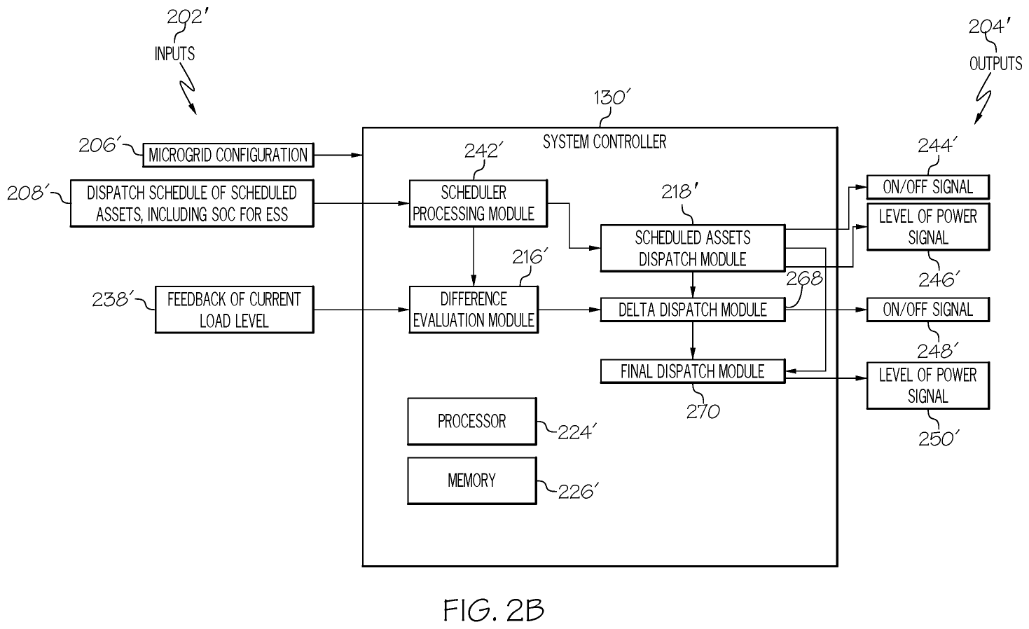

FIG. 2A shows the system controller 130 in greater detail. The system controller 130 can receive inputs 202 and generate outputs 204. The inputs 202 and the outputs 204 can be received by and generated by, respectively, one or more software modules or other components of the system controller 130. The system controller 130 may include a processor(s) 224, a memory 226, a scheduler processing module 242, a difference evaluation module 216, a scheduled assets dispatch module 218, an add/drop of non-scheduled assets module 220, and a non-scheduled assets dispatch module 222. The inputs 202 may include a microgrid configuration input 206, a microgrid dispatch schedule input 208 (which can include a state of charge of the ESS), and a feedback of current load level input 238, which may include a real and a reactive load level. The outputs 204 can be on/off signal 244 and a level of power signal 246 to the scheduled assets and an on/off signal 248 and a level of power signal 250 to the non-scheduled assets.

In general, the inputs 202 may be generated by a system operator (human) for example, at the back office 138, or remotely, or some inputs may be generated and/or determined by the system controller 130 itself. In some embodiments, the system controller, group asset controllers, or individual asset controllers can be on site outdoors or indoors (office) or connected via network remotely. The inputs 202 can be input using, for example, a human machine interface (HMI), and can be input in response to question prompts from system controller 130. In some embodiments, one or more of the outputs may be generated and/or displayed on a display, for example, an HMI. Additionally, it is to be noted that, while FIG. 2A depicts a single controller, the functions described with respect to the system controller 130 could be distributed amongst a plurality of controllers, microcontrollers, CPUs, or other processing devices.

The microgrid configuration input 206 may include information defining the assets, loads, and the overall structure of the microgrid. This input typically includes detailed information about generation assets, storage assets, loads, interconnections, grid connections, and/or control logic. For example, the microgrid configuration input 206 can include information about all power generation assets within the microgrid, including their type (e.g., solar panels, wind turbines, fuel cells), capacity, efficiency, location, and technical specifications. This information can help the system controller 130 understand the available sources of electricity. The information can also include details about energy storage assets, such as batteries or hydrogen storage systems. This includes their capacity, charge/discharge rates, and state of charge (SoC) limits. Storage assets can play a critical role in balancing supply and demand. The microgrid configuration input 206 can also include information about the electrical loads within the microgrid, including their power requirements, patterns, and priority levels. Some loads may be critical and require continuous power, while others may be less critical and can be shed during peak demand period. Information about interconnections can include how various assets and loads are interconnected within the microgrid. This includes the wiring, switchgear, and control systems that enable power flow between components. Information about the grid connection can include whether the microgrid is connected to the utility grid and how the microgrid 100 interacts with the grid. This can include information about grid tie-in points, voltage levels, and protocols for grid interactions.

The microgrid dispatch schedule input 208 can include active and reactive power scheduled commands for one or more of the assets or asset groups connected to the microgrid 100. The microgrid dispatch schedule input 208 can include a state of charge for the various ESS assets coupled to the microgrid 100. It should be understood that the scheduled group active power commands are prospective commands which can be generated during different time intervals over a predetermined future time period, and may be used, for example, as guidance for the determination of real time active and reactive power commands to be executed in an instantaneous fashion, at corresponding time intervals. In other words, the scheduled group active and reactive power commands are intended actions at various periods over a moving horizon (e.g., 12 hours, 24 hours, one week, etc.). The active and reactive power commands may be established by a predetermined future time period, and implicitly or explicitly can account for future events within that time period, e.g., variance in the load, power asset group costs, availability, or the like. The microgrid dispatch schedule input 208 can be input by a user(s), generated by software or module(s) associated with the microgrid system, or a combination of both. If generated by software or module(s) associated with the microgrid system, it may include modules for considering or forecasting utility grid pricing variations with time, forecasting of solar irradiance variation over time, forecasting of load variation over time, and the like, using algorithms based on current inputs, measurements and/or historical data.

The feedback of current load level input 238 may be the current power, scheduled power, and/or current load of the microgrid 100 as determined based on input from one or more sensors (e.g., current, voltage, power, etc. sensors). The feedback of current load level may be tracked in real time as new loads come on and off of the microgrid 100.

The system controller 130 can include a memory 226, which can include, for example, a secondary storage device, and may be coupled to one or more a processors 224, such as central processing unit(s), networking interfaces, or any other means for accomplishing tasks consistent with the present disclosure. The processor(s) 224 may be operatively coupled to the memory 226 and be configured to execute one or more instructions stored therein. The memory 226 or secondary storage device associated with the system controller 130 may store data and software to allow the system controller 130 to perform its functions, including the functions described below with respect to one or more methods, discussed in greater detail herein, and the functions of the microgrid configuration and control system described herein. The memory 226 can store, for example, one or more of the limits or thresholds described herein with respect to the various power sources and loads. Unless otherwise specifically stated, this data can be stored as one or more user selectable settings such that a user can adjust the setting via an external computing device (e.g. in the back office 138) that may be communicatively coupled with the system controller 130. The thresholds can be stored as a look-up table that stores the relevant settings for each particular type of power source and/or load. One or more of the devices or systems communicatively coupled to the system controller 130 may be communicatively coupled over a wired or wireless network, such as the Internet, a Local Area Network, WiFi, Bluetooth, or any combination of suitable networking arrangements and protocols.

In some embodiments, the memory 226 can store one or more optimal performance map(s) and/or characteristics of the power asset(s) indicated by the optimal performance map(s) may be used by the system controller 130 when performing optimizations. While the computational cost of generating or updating an optimal performance map may be high, such generating or updating may occur infrequently relative to the optimization(s) performed by the system controller 130. The optimal performance map(s) and/or characteristics of the power asset(s) indicated by the optimal performance map(s) may reduce a computational complexity of the optimization(s) performed by the system controller 130.

In some embodiments, the scheduler processing module 242 may set SOC/SOE targets among the various ESS assets. The scheduler processing module 242 can receive an input from the microgrid configuration input 206 and/or the dispatch schedule of microgrid dispatch schedule input 208. The targets can be updated from time to time based on the needs of the microgrid system For example, if it expected that an ESS will be used heavily at a later time, an ESS asset may be charged during periods of relatively little need for ESS asset usage in order for the ESS to be ready for deployment at a later time. The requested power for charging the ESS can be expressed as:

ES=(% SOC_target−% SOC_current)*(Capacity/Amount of Time Until the Next Scheduled ESS Use Time)

The amount of power provided to the ES can be limited by charge/discharge limits that may be functions of a SOC/SOE of any given ESS. The power request from a given ESS can be updated every sample of real time dispatch until a next scheduled interval, as duration and SOC are changing. The remaining load that is not a portion of the available power that is used to charge an ESS can be met by dispatching from among non-scheduled assets using rule based system or optimizer.

The scheduler processing module 242 can process microgrid schedules based on one or more priorities based on a hierarchy of constraints associated with the microgrid. That is, the dispatch of electrical assets may be segmented and/or prioritized based on priorities of operating the microgrid system. Highest priority constraints (priority 1) can include, for example, providing sufficient net power to meat loading, ensuring that no individual asset and/or no asset group exceeds its individual/group maximum limits (real and reactive), ensuring that no individual asset and/or no asset group operates below its individual/group minimum limits (real and reactive), ensuring that there is at least one grid forming asset, and maintaining resiliency/redundancy requirements. Lower priority constraints (priorities 2-5) can include, for example, maintaining a positive spinning reserve, maintaining a negative spinning reserve, maintaining an SOC/SOE within a minimum and maximum range as much as possible, charging and/or discharging based on a minimum/maximum SOC of any ESS assets on the microgrid 100, and maintaining a desired load within a desired load maximum and minimum level in order to maximize a useful life of ESS assets on the microgrid and to avoid wet stacking, for example.

In some embodiments, the scheduler processing module 242 may be configured to, for example, receive one or more scheduled power dispatch commands (e.g., from the dispatch schedule of the microgrid dispatch schedule input 208), to convert the SOC schedules to power schedules, to check a power dispatch schedule against a minimum/maximum constraint, and to revise a dispatch schedule.

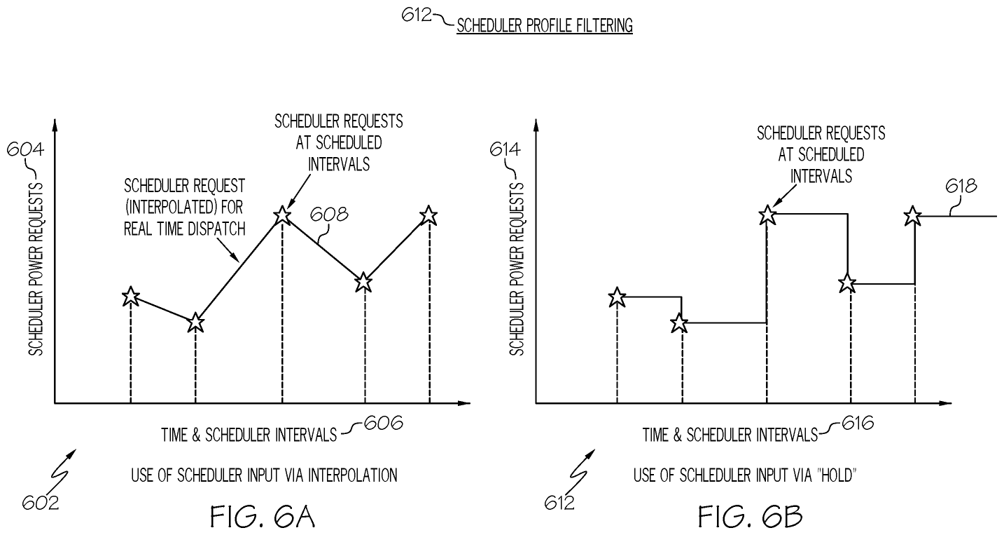

Briefly referring to FIGS. 6A and 6B, schedule profile filtering 602, 612, which may be performed in the scheduled asset dispatch module 218 is shown. Schedule profile filtering is one method of determining which scheduled assets are to be on the microgrid 100 for any particular operational time. The schedule profile filtering 602, 612 can be used to schedule one or more assets for dispatch on the microgrid 100. FIG. 6A shows a scheduler power request level 604 vs. a time and scheduler interval 606. FIG. 6B shows a scheduler power request level 614 vs. a time and scheduler interval 616. The levels 608 are interpolated from one interval to the next in FIG. 6A and the levels 618 are used via a “hold” in FIG. 6B. The determination of whether to use interpolation or hold can be incorporated in a user input (e.g., using a user input device such as an HMI). Scheduler inputs can be filtered against operating min/operating max for power, charge/discharge limits, ramp rate limits, desired min/max for SOC/SOE, and filtered data along with any interpolations. These features can be made visual on a user input device (e.g., an HMI). In some embodiments, these features may be presented automatically to a user (e.g., customer/application engineer) with a filtering profile and overwriting inputs.

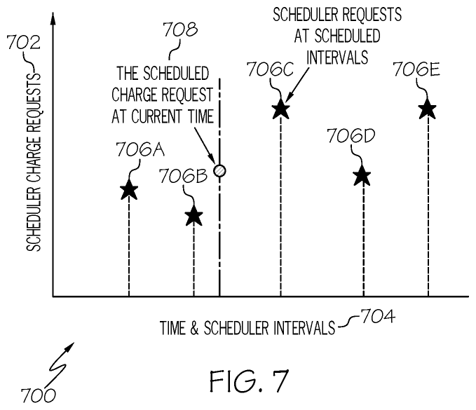

FIG. 7 shows a chart 700 showing a scheduler charge request 702 vs. a time and scheduler intervals 704. The scheduler charge requests 702 are a SOC level desired for an individual ESS asset within the microgrid and can be input, for example, by a user using a GUI or other system for interfacing with the microgrid system controller 130. As shown in FIG. 7, the hypothetical system is operating at point 708 in between two scheduled charge levels (706B, 706C) at different intervals. The scheduled charge request level at next scheduled interval may be above the scheduled charge request level at the previously scheduled interval. The scheduler processing module 242 may, for example, set an SOC/SOE target for a particular ESS asset and may generate a power request for that ESS asset based on reaching the target level. The target can be met, for example, using the equation: Power Requested=(% SOC target−% SOC_current)*(Capacity/time duration to next schedule time). The charge and discharge limits for the particular ESS asset can function to limit the charging and discharge of the ESS asset and these limits can be stored, for example, in a module of the system controller 130 (e.g., the memory 226). In embodiments, the requested power level may be updated every instance that the a real time dispatch of the various assets is sampled. The charts in FIGS. 6A and 6B illustrate different examples of inputs to the power request based on sampling of real time dispatch power signal. That is, the scheduler inputs can be input via an interpolated level as shown in FIG. 6A or can be input on as a constant (or “hold” level) based on the next or previous requested power signal. In some embodiments, a remaining load can dispatched among non-scheduled assets using a rule-based system or an optimizer-based system.

The difference evaluation module 216 may include one or more rules or logic for monitoring the actual load from each of the loads 116 and the power and energy available from the various assets coupled to the microgrid 100 to power the loads 116 in real time. The difference evaluation module 216 may calculate the difference between the current load and the available power to generate a real time capacity measurement in real and reactive power. Additionally, the difference evaluation module 216 can measure the difference between the current load and the scheduled load in real time based on the various inputs to the difference evaluation module 216.

The scheduled assets dispatch module 218 may apply real time dispatch rules to adjust operation of the microgrid 100 based on the differences calculated in the difference evaluation module 216. These rules can be rule based or optimization based depending on the situation. The scheduled assets dispatch module 218 can, for example, incorporate adaptive dispatch logic that can handle situations where scheduled sources are only partially available or not available at all. In such cases, the non-scheduled power sources could follow real-time dispatch methodologies. In the event of significant discrepancies between the scheduled dispatch and real-time conditions, the system controller 130 can revise the scheduled dispatch for assets and this revision can also follow either rule based or optimization based logic. The dispatch logic can be designed to consider various objectives, such as economic efficiency, emissions reduction, or increasing renewables penetration. The choice of objectives can depend on the goals and priorities of the microgrid 100 as determined based on, for example, user input. The scheduled asset dispatch module 218 may ensure the microgrid 100 is flexible and scalable to accommodate changes in microgrid configuration, the addition of new assets, and evolving objectives. The scheduled asset dispatch module 218 may generate the on/off signal 244 for scheduled assets and/or the level of power signal 246, for example. The add/drop of non-scheduled assets module 220 may receive an input from the difference evaluation module 216 and generate the power signal 246 for non-scheduled assets. The non-scheduled assets dispatch module 222 may receive an input from the difference evaluation module 216 and may generate the level of power signal 250 for the non-scheduled assets.

FIG. 2B shows a system controller 130′. Unless specifically stated, the system controller 130′ can have any of the features or functionality associated with the system controller 130. The system controller 130′ can receive inputs 202′ (e.g., a microgrid configuration 206′, a dispatch schedule 208′, and a feedback of current load level 238′), which may be substantially similar to the inputs 202 and can generate outputs 204′. The system controller 130′ can include a scheduled dispatch processing module 242′, a difference evaluation module 216′, a processor 224′, and a memory 226′. Unless otherwise stated, the scheduled dispatch processing module 242′, the difference evaluation module 216′, the processor 224′, and the memory 226′ can have any of the features and functionality associated with the scheduler processing module 242, the difference evaluation module 216, the processor 224, and the memory 226, respectively. The system controller 130′ also may have a scheduled assets dispatch module 218′, a delta dispatch module 268, and a final dispatch module 270.

Except as specifically stated, the scheduled assets dispatch module 218′ can have any of the features and functionality associated with the scheduled assets dispatch module 218 as well as additional features described herein. The scheduled assets dispatch module 218′ may apply real time dispatch rules to adjust operation of the microgrid 100 based on the differences calculated in the difference evaluation module 216′. These rules can be rule based or optimization based depending on the situation. The scheduled assets dispatch module 218′ can, for example, incorporate adaptive dispatch logic that can handle situations where scheduled sources are only partially available or not available at all. In such cases, the non-scheduled power sources could follow real-time dispatch methodologies. In the event of significant discrepancies between the scheduled dispatch and real-time conditions, the system controller 130 can revise the scheduled dispatch for assets and this revision can also follow either rule based or optimization based logic. The dispatch logic can be designed to consider various objectives, such as economic efficiency, emissions reduction, or increasing renewables penetration. The choice of objectives can depend on the goals and priorities of the microgrid 100 as determined based on, for example, user input. The scheduled asset dispatch module 218′ can ensure the microgrid 100 is flexible and scalable to accommodate changes in microgrid configuration, the addition of new assets, and evolving objectives. The scheduled asset dispatch module 218′ may generate the on/off signal 244′ for scheduled assets and/or the level of power signal 246′, for example.

The delta dispatch module 268 is a module that can dispatch a difference between a scheduled load and a non-scheduled (i.e., a delta load) to one or more non-scheduled assets. The delta dispatch module 268 can receive an input from the difference evaluation module 216′ and the scheduled assets dispatch module 218′ and can generate the on/off signal 248′ for non-scheduled assets. The final dispatch module 270 may receive an input from the delta dispatch module 268 and the scheduled assets dispatch module 218′ and may generate the level of power signal 250′ for the non-scheduled assets.

### INDUSTRIAL APPLICABILITY

The disclosed aspects of the present application can be used to optimally manage hybrid power systems on microgrids. Currently, microgrid systems may not effectively manage and dispatch microgrid power generation assets individually based on their individual limits when considered in the context of system-wide operation. This can be, in particular, difficult to manage for any given ESS asset on the microgrid which has individual charging and discharge limits for any given scenario.

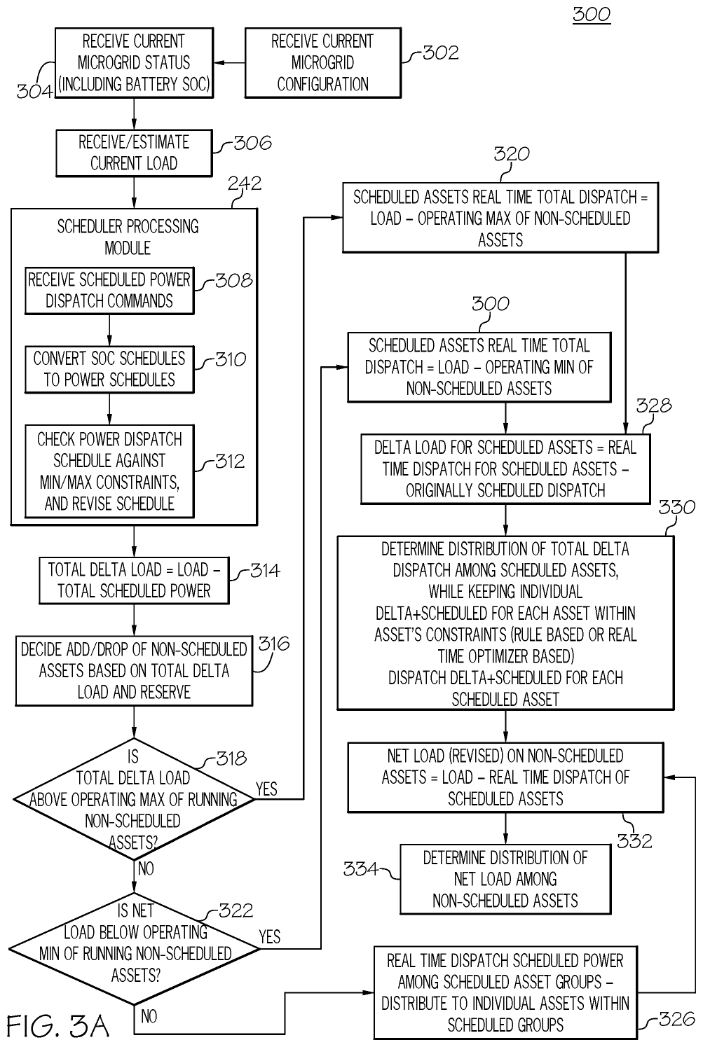

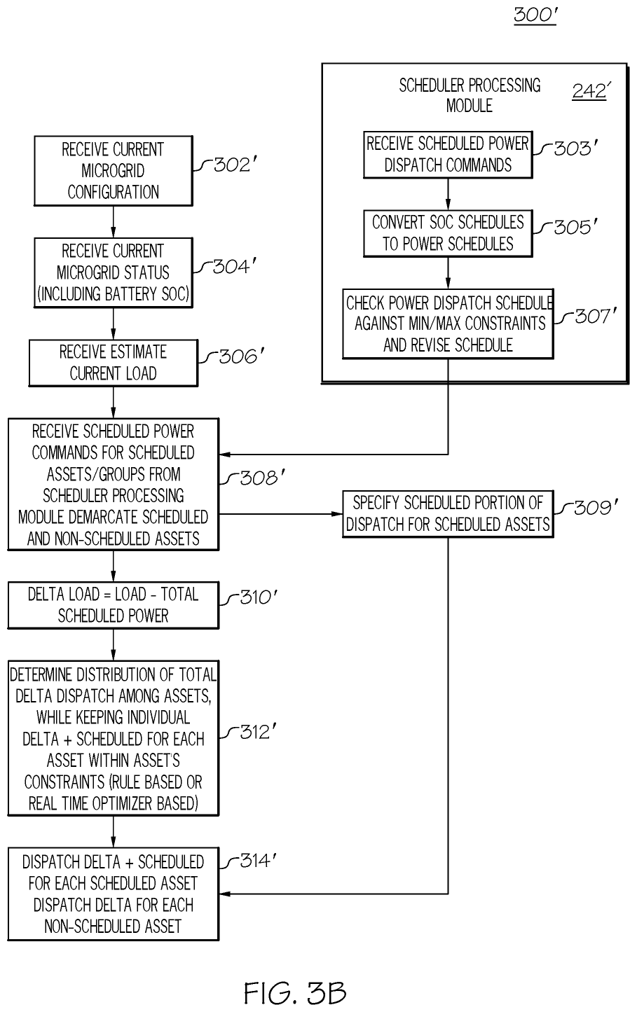

Referring to FIG. 3A, a method 300 of operating a microgrid, such as the microgrid 100 of FIG. 1 using the system controller 130 of FIG. 2A, is shown. It is to be understood that the individual steps of the method shown in FIG. 3A are merely exemplary and implementations of the method may include more or fewer steps to those shown in FIG. 3A.

At steps 302 and 304, the system controller 130 may receive the current microgrid configuration and microgrid status. This information can include detailed data about the microgrid's assets, loads, and structure (including a SOC or SOE of any of the ESS assets on the grid) and can be based on, for example, the microgrid configuration input 206. This can include information about types of assets (e.g., solar panels, wind turbines, fuel cells), capacity ratings, technical specifications (such as efficiency and conversion rates), geographic locations, and operational statuses, as well as data on energy storage assets, such as batteries or hydrogen storage systems. This input can include the capacity of each storage unit, charge and discharge rates, state of charge (SOC) limits, state of energy (SOE), as well as any specific operational requirements. This can further include identifying types of loads (e.g., residential, commercial, industrial), their power requirements, load patterns (including peak and off-peak periods), and priority levels (critical vs. non-critical). It can also include how various assets and loads are interconnected within the microgrid including information on electrical wiring, switchgear, circuit protection, and control systems used to facilitate power flow between different components. If the microgrid 100 is grid-connected (i.e., to the utility grid 104), it can include information on how the microgrid interacts with the utility grid 104 including grid tie-in points, voltage levels, and protocols for grid interactions, such as frequency regulation, islanding capabilities, and demand response capabilities. The configuration and status can also include details about any predefined control logic or operating modes. This can encompass rules for load shedding during peak demand, strategies for optimizing renewable energy self-consumption, and protocols for switching between grid and islanded modes during grid outages. The configuration and status can also include environmental data, such as weather conditions, weather forecasts, and local climate patterns, to account for factors like solar irradiance and wind conditions. The information can also include economic considerations, such as utility pricing schedules, tariffs, and any financial incentives or penalties associated with grid interactions.

At step 306, the system controller 130 may receive and/or may estimate the current load level on the system. This information can come from, for example, the current load level input 238 (as measured from various sensors or other measuring devices within the microgrid 100) or can be an estimate based on one or more schedule inputs, based on historical loads (as saved in the memory 226, for example), or can be based on one or more other inputs. The current load level (estimate or actual) can be used to determine a required electrical output, which may be used in one or more other steps of the method 300.

At step 308, the system controller 130 may receive scheduled power dispatch commands. This information can be received based on, for example, the dispatch schedule of microgrid dispatch schedule input 208. At step 310, the system controller 130 may convert the SOC schedules to power schedules. This conversion can involve converting an expected SOC into a required power for reaching the SOC at a given time and can be based on, for example, the current SOC for an ESS asset and a desired SOC for the same ESS asset.

At step 312, the system controller 130 may check a power dispatch schedule against minimum and maximum constraints and may revise the power dispatch schedule based on the constraints. The minimum and maximum constraints can be part of one or more signals from the microgrid dispatch schedule input 208, can be stored in the memory 226 and recalled based on the microgrid configuration input 206, or may be delivered to the system controller 130 from some other source.

At step 314, the system controller 130 may determine a total delta load on the microgrid 100 by subtracting a total scheduled power, as determined by the microgrid dispatch schedule input 208, for example, from a load on the system, as determined by the current load level input 238. This difference can be determined in the difference evaluation module 216. The total delta load may be referred to as “net load” in some of the figures to save space in the figures.

At step 316, the system controller 130 may determine whether to add or drop one or more non-scheduled assets based on a total delta load and a reserve load. This determination can be made, for example, in the difference evaluation module 216. At step 318, the system controller 130 may determine whether the net load is above an operating max of running non-scheduled assets. If the net load is above the operating max of running non-scheduled assets, the system controller 130 may determine whether scheduled assets real time total dispatch=load−operating max of non-scheduled assets and whether a delta load for scheduled assets=real time dispatch for scheduled assets−originally scheduled dispatch at step 320.

However, if the answer is no at step 318, the system controller 130 may determine whether net load is below the operating minimum of non-scheduled assets at step 322. If no, the system controller 130 may perform real time dispatch of scheduled power among the scheduled asset groups in order to distribute to individual assets within the scheduled asset groups at step 326. If yes, the system controller 130 may determine to dispatch scheduled assets in real time based on a comparison of the load minus the operating minimum of non-scheduled assets at step 324.

At step 328, the system may determine a delta load for scheduled assets. This delta load can be equal to a real time dispatch for scheduled assets less an originally scheduled dispatch of the assets. Based on this difference, the system controller 130 may determine a distribution of total delta dispatch among scheduled assets, while keeping individual delta plus the scheduled dispatch for each asset within the individual asset's constraints and may dispatch assets based on a delta load plus a scheduled load for each of the scheduled assets at step 330.

At step 332, the system controller 130 may determine a net load (revised) on the non-scheduled assets. This net load on the non-scheduled assets may be a load less a real time dispatch of scheduled assets. At step 334, the system controller 130 may determine a distribution of the net load calculated at step 332 amongst the non-scheduled assets. These determined distributions may eventually be distributed to the various assets within the system.

Referring now to FIG. 3B, a method 300′ of operating a microgrid such as the microgrid 100 of FIG. 1 using the system controller 130′ of FIG. 2B is shown. At steps 302′ and 304′, the system controller 130′ may receive the current microgrid configuration and status. This information can include detailed data about the assets, loads, and structure of the microgrid 100 and can be based on, for example, the microgrid configuration input 206. This can include information about types of assets (e.g., solar panels, wind turbines, fuel cells), capacity ratings, technical specifications (such as efficiency and conversion rates), geographic locations, and operational statuses, as well as data on energy storage assets, such as batteries or hydrogen storage systems. This input can include the capacity of each storage unit, charge and discharge rates, SOC limits, SOE, as well as any specific operational requirements. This can further include identifying types of loads (e.g., residential, commercial, industrial), their power requirements, load patterns (including peak and off-peak periods), and priority levels (critical vs. non-critical). It can also include how various assets and loads are interconnected within the microgrid including information on electrical wiring, switchgear, circuit protection, and control systems used to facilitate power flow between different components.

At step 306′, the system controller 130 may receive and/or may estimate the current load level on the system. This information can come from, for example, the current load level input 238 (as measured from various sensors or other measuring devices within the microgrid 100) or can be an estimate based on one or more schedule inputs, based on historical loads (as saved in the memory 226, for example), or can be based on one or more other inputs. The current load level (estimate or actual) can be used to determine a required electrical output, which may be used in one or more other steps of the method 300.

At steps 303′, 305′, and 307′, the system controller 130 may receive scheduled power dispatch commands, convert the SOC schedules to power schedules, and check a power dispatch schedule against minimum and maximum constraints to revise the power dispatch schedule. The conversion can involve converting an expected SOC into a required power for reaching the SOC at a given time and can be based on, for example, the current SOC for an ESS asset and a desired SOC for the same ESS asset. Steps 303′, 305′, and 307′ can be substantially similar to steps 308, 310, and 312 of method 300 unless otherwise specifically stated.

At step 308′ scheduled power commands for scheduled assets and groups can be received from the scheduler processing module and scheduled assets may be demarcated from the non-scheduled assets. At step 309′ the scheduled portion of dispatch for scheduled assets can be specified.

At step 310′ a delta load can be calculated. The delta load can be calculated as the load (as determined by, for example, the feedback of current load level input 238) less the total schedule power, which is received from the scheduler processing module 242′. At step 312′ a distribution of total delta load for dispatch among assets can be determined. The total delta dispatch among assets can be determined while keeping individual assets within their individual asset constraints. At step 314′, the delta load and the scheduled load for each scheduled asset can be dispatched along with the delta load for the non-scheduled assets.

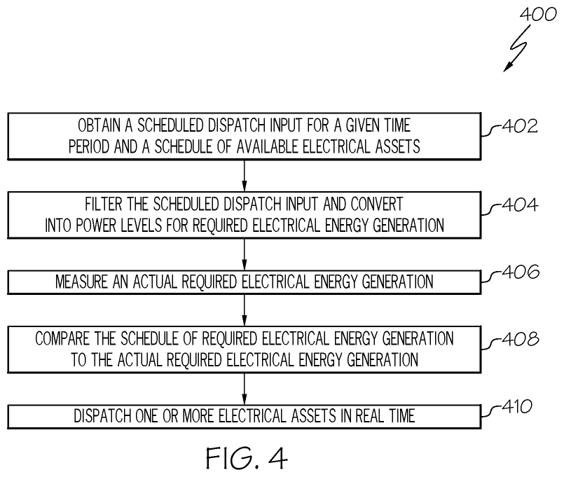

FIG. 4 shows another method 400 of operating a microgrid system, such as the microgrid 100 of FIG. 1. The method 400 could be, for example, one implementation of the method shown in FIGS. 3A and 3B and could be executed using one or more of the features shown in FIGS. 1 and 2A/2B (e.g., one or more inputs 202, outputs, 204 or modules of the system controller 130 of the microgrid 100). It is to be understood that the individual steps of the method 400 are merely exemplary and implementations of the method 400 may include more or fewer steps to those shown in FIG. 4.

At step 402, a scheduled dispatch input that includes a schedule of required electrical energy generation for the microgrid system for a given time period and a schedule of electrical assets capable of meeting the schedule of required electrical energy generation may be obtained. The scheduled dispatch input can be provided to the system controller 130 as data included in, for example, the microgrid dispatch schedule input 208 and can include one or more scheduled asset or asset group active power commands for a plurality of assets or asset groups. The microgrid dispatch schedule input 208 can be a dynamic input and may be input by a user(s), generated by software or module(s) associated with the microgrid system, or a combination of both. Additionally, various of the modules of the system controller 130 may leverage historical data and real-time information to optimize the schedule, for example, the system controller 130 may leverage a load forecaster or similar feature to forecast one or more loads on the microgrid 100. In some embodiments, the forecast can include one or more of a forecasted cloud cover, forecasted weather, and forecasted wind speed data.

At step 404, the scheduled dispatch input may be filtered and converted into power levels, refining the input to meet power demands for required electrical energy generation of the scheduled dispatch input for the microgrid system. The scheduled dispatch input can be filtered and converted, for example, using a rules module, which may be driven by one or more algorithms and decision-making logic. The power levels may correspond to the different levels of power required to meet the loading demands on the microgrid throughout a given time period (e.g., a number of kW, etc.), accounting for variations in demand throughout the specified time period. This transformation can ensure that the microgrid operates efficiently by matching power generation with demand.

At step 406, an actual required electrical energy generation for the microgrid system based on one or more electrical loads electrically coupled to the microgrid system may be measured. The energy measurement can be made by receiving an energy requirement from each of the various electrical loads attached to the system and summing each of the loads, quantifying the total requirement. Accurate measurement of the actual load enables the microgrid 100 to respond accurately to changes in load and/or generated power levels as required. The sum can be input to the system controller 130 as, for example, a current load level input 238. In some embodiments, the current load level input 238 can be a simulated actual required electrical energy level based on the type and number of assets coupled to the grid and one or more predictions as generated by, for example, a grid forecaster and/or a renewable energy generation forecaster.

At step 408, the schedule of required electrical energy generation may be compared to the actual required electrical energy generation for the microgrid system. The comparison can lead to a determination of a difference between a scheduled required electrical energy generation and an actual required electrical energy generation. Additionally, the comparison can serve as a diagnostic tool, allowing the system controller to assess the alignment between planned and real-world conditions. Disparities detected between the scheduled and actual energy generation requirements may indicate inefficiencies, deviations, or unexpected events within the microgrid system as well as inaccuracies generated in the forecasts using one or more of a grid forecaster, a renewable energy generation forecaster, and/or a load forecaster. The schedule of required electrical energy generation may be updated periodically (e.g., by a user or by software).

At step 410, one or more electrical assets may be dispatched in real time to meet a difference between the scheduled required electrical energy generation and the actual required electrical energy generation. Dispatch of assets in real time provides a dynamic response to meet electrical load requirements of the microgrid 100. Any additionally or alternatively required assets may be dispatched via a dispatch signal (on/off signal 244 and/or level of power signal 246) generated by the scheduled assets dispatch module 218 of the system controller 130, for example. Dispatching one or more electrical assets on-demand ensures that the microgrid maintains a stable and reliable energy supply. These assets may be activated or deactivated as needed, optimizing the microgrid's performance while adhering to energy generation schedules and addressing unforeseen variations in demand. Dispatching of one or more electrical assets can be optimized and be based on one or more modes including an economics mode, a minimum emissions mode, and a maximum renewables penetration mode as determined based on logic stored in one or more of the scheduled asset dispatch module 218 (which can include, for example, a load manager), or another module of the system controller 130, for example.

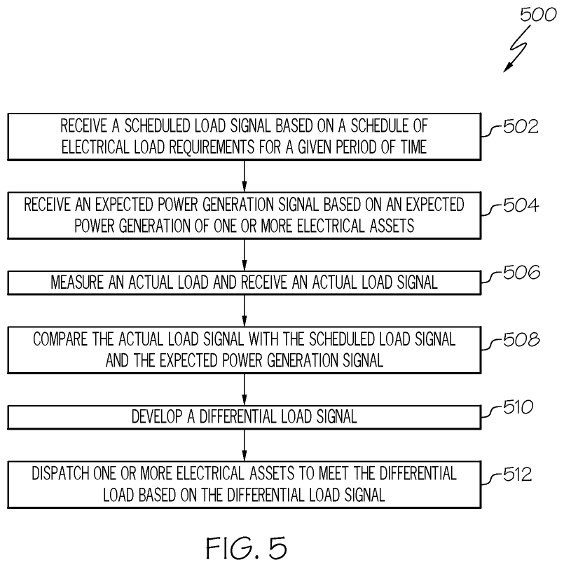

Referring to FIG. 5, a method 500 of operating a microgrid system, such as the microgrid 100 of FIG. 1 is shown. The method 500 could be, for example, one implementation of the method shown in FIG. 3A/3B and could be executed using one or more of the features shown in FIGS. 1 and 2 (e.g., one or more inputs 202, outputs, 204 or modules of the system controller 130 of the microgrid 100). It is to be understood that the individual steps of the method 500 are merely exemplary and implementations of the method 500 may include more or fewer steps to those shown in FIG. 500.

At step 502, a scheduled load signal may be received. The scheduled load signal can be based on a schedule of electrical load requirements for the microgrid system for a given period of time. The scheduled load signal can be received based on, for example, a microgrid dispatch schedule input 208 and/or based on a current load level input 238. The scheduled load signal input can include one or more scheduled asset or asset group active power commands for a plurality of assets or asset groups. The system controller 130 may utilize one or more other modules or inputs of the system controller 130 to generate or receive the scheduled load signal (e.g., a load forecaster) that can include one or more of a forecasted cloud cover, forecasted weather, and forecasted wind speed data.

At step 504, an expected power generation signal based on an expected power generation of one or more electrical assets electrically coupled to the microgrid system may be received. The expected power generation signal may be based on the total expected power generation of the one or more assets on the microgrid 100 and can be generated by, for example, a grid forecaster. The expected power generation signal can be based on the microgrid configuration input 206 as the microgrid configuration will determine the expected power generation level. In some embodiments, the expected power generation signal can be based on one or more of an expected power generation of one or more renewable assets and a utility cost (e.g., of the utility grid 104). In some embodiments, the expected power generation of one or more renewable assets can be based on data related to one or more of average cloud cover, historical weather data, and historical wind speed data.

At step 506, an actual load can be measured. The actual load may be measured at a measuring time that is within the given period of time. Further, an actual load signal may be received to determine an actual load on the microgrid system based on comparison with the measured load. The measured load can be measured using one or more meters, counters, testers, etc. that may be appropriately electrically coupled to the microgrid system.

At step 508, the actual load signal may be compared with the scheduled load signal and the expected power generation signal. The comparison can be made, for instance in the difference evaluation module 216, which may generate a signal that can be used as an input to the scheduled asset dispatch module 218 and at step 510, a differential load signal may be developed based on a difference between the scheduled load signal, the expected power generation signal, and the actual load signal.

At step 512, one or more electrical assets may be dispatched to meet the differential load based on the differential load signal. The electrical assets may be dispatched using, for example, a dispatch signal generated in the scheduled asset dispatch module 218 of the system controller 130. In some embodiments, the dispatching of one or more electrical assets can be based on one or more modes including an economics mode, a minimum emissions mode, and a maximum renewables penetration mode. In some embodiments, dispatch of one or more energy storage systems to meet differential load requirements can be reduced in priority based on a SOC and SOE of the energy storage system. For example, if the SOC and/or SOE is below an optimal threshold. Indeed, in some embodiments, the system controller 130 may be configured to not place an energy storage system on the microgrid if the SOC/SOE is below a minimum threshold. Such minimum values can be stored, for example, in a memory 226 of the system controller 130.

As explained in greater detail herein above, the systems and methods disclosed herein propose and explain balanced operation for microgrid systems that can leverage priorities evident from cost functions, incorporate different set points based on life and efficient operating points based on power and/or energy, and accommodate diverse energy generation and storage assets. Such an approach can significantly enhance the efficiency, optimal operation, and sustainability of microgrid systems, contributing to the advancement of the renewable energy sector.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A method of operating a microgrid system comprising:
obtaining a microgrid dispatch schedule input that includes a schedule of required electrical energy generation for the microgrid system for a given time period and a schedule of electrical assets capable of meeting the schedule of required electrical energy generation;
filtering the scheduled dispatch input and converting the scheduled dispatch input into power levels to meet power demands for required electrical energy generation of the dispatch schedule input for the microgrid system;
receiving a current load level for the microgrid system based on one or more electrical loads electrically coupled to the microgrid system;
comparing the schedule of required electrical energy generation to an actual required electrical energy generation for the microgrid system to determine a difference between scheduled required electrical energy generation and the actual required electrical energy generation; and
dispatching one or more electrical assets in real time to meet a difference between the scheduled required electrical energy generation and the actual required electrical energy generation.

2. The method of claim 1, wherein the one or more electrical assets are dispatched in real time based on constraints that are segmented into groups of different priorities.

3. The method of claim 1, wherein the schedule of required electrical energy generation and the schedule of electrical assets capable of meeting the required electrical energy generation are updated periodically.

4. The method of claim 1, wherein the one or more electrical assets include one or more of one or more gensets, one or more energy storage systems, one or more renewable energy resource assets, and a utility grid.

5. The method of claim 4, wherein the one or more renewable energy resource assets include one or more of a photovoltaic asset and a wind turbine.

6. The method of claim 1, wherein one or more renewable energy resource assets are dispatched based on a forecasted cloud cover, forecasted weather, and forecasted wind speed data.

7. The method of claim 1, wherein the dispatching of one or more electrical assets is based on one or more modes including an economics mode, a minimum emissions mode, and a maximum renewables penetration mode.

8. A method of operating a microgrid system comprising:
receiving a scheduled load signal based on a schedule of electrical load requirements for the microgrid system for a given period of time;
receiving an expected power generation signal based on an expected power generation of one or more electrical assets electrically coupled to the microgrid system;
measuring an actual load at a measuring time that is within the given period of time and receiving an actual load signal to determine an actual load on the microgrid system;
comparing the actual load signal with the scheduled load signal and the expected power generation signal;
developing a differential load signal based on a difference between the scheduled load signal, the expected power generation signal, and the actual load signal;
dispatching one or more electrical assets to meet the differential load based on the differential load signal.

9. The method of claim 8, wherein the scheduled load is input by a user of the microgrid system.

10. The method of claim 8, wherein the expected power generation signal is based on one or more of an expected power generation of one or more renewable energy resource assets and a utility cost.

11. The method of claim 10, wherein the expected power generation of one or more renewable energy resource assets is based on data related to one or more of average cloud cover, historical weather data, and historical wind speed data.

12. The method of claim 8, wherein the dispatching of one or more electrical assets is based on one or more modes including an economics mode, a minimum emissions mode, and a maximum renewables penetration mode.

13. The method of claim 8, wherein the one or more electrical assets are dispatched in one or more groups of electrical assets.

14. The method of claim 8, wherein the one or more assets dispatched to meet the electrical load are grid following assets.

15. A controller for a microgrid system comprising:
at least one memory storing instructions;
at least one processor, operatively connected to the memory and configured to execute the instructions to:
receive a scheduled load signal based on a schedule of electrical load requirements for the microgrid system for a given period of time;
receive an expected power generation signal based on an expected power generation of one or more electrical assets electrically coupled to the microgrid system;
measure an actual load at a measuring time that is within the given period of time and receiving an actual load signal to determine an actual load on the microgrid system;
compare the actual load signal with the scheduled load signal and the expected power generation signal;
develop a differential load signal based on a difference between the scheduled load signal, the expected power generation signal, and the actual load signal;
dispatch one or more electrical assets to meet the differential load based on the differential load signal.

16. The controller of claim 15, wherein one or more energy storage systems are prioritized to be dispatched to meet the differential load based on a state of charge and a state of energy of the one or more energy storage systems.

17. The controller of claim 16, wherein the energy storage systems are reduced in priority if a state of charge and state of energy of the energy storage system is below an optimal threshold.

18. The controller of claim 17, wherein the controller is configured to not place the energy storage systems on the microgrid system based on a state of charge and state of energy of the energy storage system being below a minimum threshold.

19. The controller of claim 15, wherein the expected power generation signal is based on one or more of an expected power generation of one or more renewable energy resource assets and a utility cost.

20. The controller of claim 16, wherein the expected power generation of one or more renewable energy resource assets is based on data related to one or more of average cloud cover, historical weather data, and historical wind speed data.
